(19) United States
(12) Patent Application Publication
(10) Pub. No.: US 2024/0043746 A1
(43) Pub. Date: Feb. 8, 2024

(54) Apparatus method and composition for soil treatment

(71) Applicant: Brent Smith, De Witt, IA (US)

(72) Inventor: Brent Smith, De Witt, IA (US)

(21) Appl. No.: 17/803,523

(22) Filed: Aug. 8, 2022

(51) Int. Cl. C09K 17/50

(52) U.S. Cl. CPC C09K 17/50

(57) ABSTRACT

A soil treatment may include vermicompost and at least one component chosen from the group of: a calcium source component, an organic component. A calcium source component may be gypsum. An organic source may be humus.

### BACKGROUND

Inventive concepts relate generally to an apparatus, method, and composition for a soil treatment. In particular, inventive concepts relate to an apparatus, method, and composition for a soil treatment to be used in agricultural, residential, recreational, gardening or commercial plant growth. Although inventive concepts may be used in conjunction with any type of plant growth promotion, for brevity and clarity the following non-limiting descriptions will be directed primarily toward turf applications, such as those that may be employed in enhancing soils for golf courses or residential lawns, for example.

In the process of creating soil, bedrock is broken down into “parent material” by natural forces, such as freezing and thawing, wetting and drying, erosion (wind and water), and glacial scraping, for example. The “parent material,” in turn, breaks into mineral particles of sand, silt or clay. At some point the mineral material becomes capable of supporting plant life, and the plant life, by further breaking up rocks and by holding soil in place, helps create different types of topsoil. Different types of plant growth also help to create different types of soil. When the plants die, their decomposition returns nutrients to the soil. If the plants are removed (through crop harvesting, for example), nutrients are not returned to the soil and the soil may become depleted.

Crop domestication began approximately ten thousand years ago and, although natural processes such as the yearly flooding of the Nile revitalize soils, early farmers learned that soils can be depleted through repeated harvesting and that they may benefit from artificial, that is, man-made, fertilization. Approximately eight thousand years ago early farmers fertilized their crops with manure and, for thousands of years, manure was the main source of fertilizer. During the eighteenth century it was discovered that ground-up bones provide soil nutrients (approximately 15% phosphorus, 4% nitrogen and lower amounts of other nutrients such as calcium) and, in response, bones from slaughterhouses were ground up to make bone meal fertilizer. In the United States, mountainous piles of bison skulls were ground up to be used as bone meal fertilizer.

The modern era of soil chemistry and plan nutrition began in the nineteenth century, with Liebeg's Theory of Mineral Nutrients establishing that the chemical properties of nitrogen (N), phosphorous (P) and potassium (K) are key to plant health and growth. Liebeg established that these plant nutrients could be depleted by crop removal and that adding fertilizer to the soil replaces nutrients lost to crop removal. Subsequently, Nobel Prize winning Chemists Carl Bosch and Fritz Haber developed the Haber process, which employs molecular nitrogen and methane gas to produce ammonia. Ammonia, in turn, may be applied directly to the soil to replenish nitrogen or may be used to create other nitrogen-rich fertilizers. Wilhelm Ostwald's “Ostwald process” uses ammonia produced by the Haber process to produce nitric acid. By the beginning of the twentieth century, processes for the production of ammonia and nitric acid, the basic components of many fertilizers, were developed but in limited use.

Although ammonia and nitric acid could be manufactured by the early twentieth century, until the middle of the twentieth century, the use of chemical fertilizer was limited; manure, plowed-down legumes, bone meal and blood meal were still the dominant modes of fertilization. With the start of World War II, the production of nitrogen, a principal component in explosives, skyrocketed. New nitrogen production plants employed natural gas to produce the nitrogen. After the war the nitrogen plants were repurposed for the production of fertilizer. Additionally, a process for producing phosphates by acidulating rock phosphate was developed, and large deposits of potash were discovered around the world. Chemical (that is, man-made) fertilizers helped to increase food production to a level unimaginable in the middle of the twentieth century.

Recently, a spike in the cost, and limitations on the availability, of natural gas, and supply chain and other issues related to procurement of an adequate supply of potash and rock phosphate, have exposed vulnerabilities to reliance upon chemical fertilizers for agricultural, residential, recreational and commercial soil replenishment.

A soil treatment that may be used in place of, or to supplement, chemical fertilizers may therefore be of great utility.

### SUMMARY OF THE INVENTION

In example embodiments in accordance with principles of inventive concepts, a soil treatment includes vermicompost; and at least one chosen from the group of: a calcium source component, an organic compound component.

In example embodiments a soil treatment includes a calcium-source component including gypsum.

In example embodiments a soil treatment includes an organic-compound source component that includes humus.

In example embodiments a soil treatment includes a vermicompost component that is at least 5% by weight.

In example embodiments a soil treatment includes a calcium-source component that is at least 5% by weight.

In example embodiments a soil treatment includes an organic compound component that is at least 5% by weight.

In example embodiments a soil treatment is in dry form.

In example embodiments a soil treatment is in powder form.

In example embodiments a soil treatment is in pellet form.

In example embodiments a soil treatment includes a biological-restriction relieving component; and at least one chosen from the group of: a chemical-restriction relieving component, a physical-restriction relieving component.

In example embodiments a soil treatment includes a biological-restriction relieving component that includes vermicompost.

In example embodiments a soil treatment includes a physical-restriction relieving component that includes gypsum.

In example embodiments a soil treatment includes a chemical-restriction relieving agent that includes an organic material.

In example embodiments a soil treatment includes organic material that includes humus.

In example embodiments a soil treatment includes organic material that includes fulvic acid.

In example embodiments a soil treatment includes organic material that includes humic acid.

A method of treating soil in accordance with principles of inventive concepts includes, preparing a mix of vermicompost and at least one from the group of: gypsum and humus; and applying the mix to the soil.

A method of treating soil in accordance with principles of inventive concepts includes forming a mix into pellets before application to the soil.

A method of treating soil in accordance with principles of inventive concepts includes preparing the proportion of mix components according to physical, biological, or chemical characteristics of the soil to be treated.

A method of treating soil in accordance with principles of inventive concepts includes preparing the proportion of mix components by adjusting the level of a calcium-contributing component according to the acidity of the soil.

A method of treating soil in accordance with principles of inventive concepts includes, testing the soil to be treated for chemical, physical, or biological characteristics.

### BRIEF DESCRIPTION OF THE DRAWINGS

Example embodiments in accordance with principles of inventive concepts will be more clearly understood from the following detailed description taken in conjunction with the accompanying drawings in which:

FIG. 1 is a flow chart depicting an example process of treating soil in accordance with principles of inventive concepts.

### DETAILED DESCRIPTION

Example embodiments in accordance with principles of inventive concepts will now be described more fully with reference to the accompanying drawings, in which example embodiments are shown. Example embodiments in accordance with principles of inventive concepts may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. Like reference numerals in the drawings denote like elements, and thus their description may not be repeated. Example embodiments of systems and methods in accordance with principles of inventive concepts will be described in reference to the accompanying drawings and, although the phrase “example embodiments in accordance with principles of inventive concepts” may be used occasionally, for clarity and brevity of discussion example embodiments may also be referred to as “Applicants' system,” “the system,” “Applicants' method,” “the method,” or, simply, as a named component or element of a system or method, with the understanding that all are merely example embodiments of inventive concepts in accordance with principles of inventive concepts.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “or” includes any and all combinations of one or more of the associated listed items. Other words used to describe the relationship between elements should be interpreted in a like fashion (for example, “between” versus “directly between,” “adjacent” versus “directly adjacent,” “on” versus “directly on”). The word “or” is used in an inclusive sense, unless otherwise indicated.

It will be understood that, although the terms “first”, “second”, etc. may be used herein to describe various elements, components, regions, layers, process steps, or sections, these elements, components, regions, layers, process steps, or sections should not be limited by these terms. These terms are only used to distinguish one element, component, region, step, layer, process step, or section from another element, component, region, step, layer or section. Thus, a first element, component, region, step, layer, process step, or section discussed below could be termed a second element, component, region, step, layer, process step, or section without departing from the teachings of example embodiments.

Spatially relative terms, such as “beneath,” “below,” “lower,” “above,” “upper,” “top,” “bottom,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if an element in the figures is turned over, elements described as “bottom,” “below,” “lower,” or “beneath” other elements or features would then be oriented “atop,” or “above,” the other elements or features. Thus, the example terms “bottom,” or “below” can encompass both an orientation of above and below, top and bottom. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” or “including,” if used herein, specify the presence of stated features, integers, steps, operations, elements or components, but do not preclude the presence or addition of one or more other features, integers, steps, operations, elements, components or groups thereof. The word “or” is used in an inclusive sense to mean both “or” and “and/or.” The term “exclusive or” will be used to indicate that only one thing or another, not both, is being referred to.

Unless otherwise defined, all terms (including technical and scientific terms) used herein have the same meaning as commonly understood by one of ordinary skill in the art to which example embodiments in accordance with principles of inventive concepts belong. It will be further understood that terms, such as those defined in commonly-used dictionaries, should be interpreted as having a meaning that is consistent with their meaning in the context of the relevant art and will not be interpreted in an idealized or oyerly formal sense unless expressly so defined herein.

Although, generally, the term “prill” may refer to a pellet, a granule, or small bead, the terms “prill” and “pellet” may be used interchangeably herein and, whether prill or pellet, the item may be formed by compressing, prilling (solidifying droplets as they fall), or other method.

For clarity and brevity of description, inventive concepts may be described in terms of example embodiments related to turf treatments, such as golf course turf treatments, but all plant growth applications, including agricultural, lawn, and gardening applications, are contemplated within the scope of inventive concepts.

Soil nutrients may be depleted when crops are harvested, with the nutrients that would naturally be returned to the soil carried off for human consumption. But that is not the only way in which nutrients are made unavailable for plant growth. Those nutrients that remain in the soil may become unavailable to plants, due to various soil restrictions. Such restrictions may be due to any of number of reasons, including physical, chemical, or biological restriction factors.

Physical restrictions may result from the compaction of sol. Soil particles may be compressed, for example, by foot traffic, vehicle traffic, equipment traffic, the moving of soil and other natural processes that reduce pore space in the soil profile. With compacted soil, plant roots may be unable to grow and access nutrients through symbiotic plant/soil processes that extract existing nutrients from the soil. Compaction also negatively affects the biological process of microbial mining and cycling nutrients due to the compacted soil's resultant lack of oxygen.

Chemical restrictions, the chemical imbalance of nutrients such as soil pH and Calcium/Magnesium ratios, along with other nutrient imbalances render nutrients unavailable for plant uptake, even in cases where the nutrients may be present in the soil.

Biological restrictions impinge upon microbial nutrient recycling, limiting the plant-availability of soil nutrients. Biological restrictions may be due to pesticide use, a lack of oxygen within the soil profile, high sand content of the soil, or low organic matter (food source) for microbial proliferation, for example.

In accordance with principles of inventive concepts a method, apparatus and composition of matter may be employed to make soil nutrients within the soil available to plants that are otherwise unavailable, thereby increasing the photosynthetic activity of plants and increasing the health of the plants. Soils may also be supplemented with nutrients. In this manner inventive concepts may contribute to a reduction in the use of synthetic fertilizers (also referred to herein as chemical fertilizers) and pesticides, resulting in a healthier ecosystem, reducing costs, and decoupling from international supply chains and their associated vulnerabilities.

In example embodiments a plurality of ingredients may be combined to treat soil in a manner that supplements soil nutrients or makes existing nutrients within the soil more available to plant life.

In example embodiments a mix of soil-treatment components may be provided to the soil topically or incorporated, for example, through tilling. The mix may be in a dry form, such as powder, pellet, prill, or other form, for example.

In example embodiments the soil treatment mix may be tailored to a specific soil type or may be a predetermined mix of soil nutrients. In example embodiments, different mixes may be provided for different soil types, for example, as pre-defined “standard” mixes. In example embodiments, a particular soil-treatment mix may be provided for a specific soil in response to soil testing. In accordance with principles of inventive concepts, a soil treatment mix may include a physical restriction relieving agent, a chemical restriction relieving agent, or a biological restriction relieving agent. In some embodiments a soil treatment mix may include calcium, organic and vermicompost components. In some embodiments a soil enhancement mix may include organic and vermicompost components. In some example embodiments a soil enhancement mix may include calcium and vermicompost components.

In example embodiments calcium sulfate (Ca SO4) may be employed as a physical restriction relieving agent gypsum (CaSO4 2h2O) is the widely-available dihydrate form of calcium sulfate. The Calcium of Calcium Sulfate may flocculate the soil, opening up physical pore space and thereby allowing more oxygen into the soil profile. It may also promote more biological activity, allowing microbes to better cycle nutrients for plant availability. Other calcium sources may include: dolomitic lime, or calcitic lime (also referred to as “high cal lime”), for example.

The sulfate portion of gypsum operate to relieve chemical soil restrictions, acting directly to acidify the soil, lowering its pH. Soil nutrients may have their best plant availability when the soil pH is in the 5.5-6.5 pH range. Other agents, such as calcium carbonate (CaCO3), sometimes referred to as “high Cal Lime” may be employed as chemical restriction relieving agents, to, for example, improve low pH soils (soils with pH below 5.5) to a pH within a desired range (between 5.5 and 6.5, for example). Another chemical restriction relieving agent, one that may address deficient magnesium levels in soil, that may be employed in accordance with principles of inventive concepts may be dolomitic lime (CaMgCO3). In example embodiments, soil testing may reveal a magnesium deficiency in the soil and dolomitic lime may be employed to boost the magnesium level of the soil.

In example embodiments organic matter (including, humus or humic acid, or fulvic acid, for example) may be employed as a biological-restriction relieving agent, providing organic materials that may be a direct food source for biological/microbial populations within the soil. In the following, the terms “humic, humic acid, fulvic acid, and humus” will all be used to refer, generally, to organic matter that may be used as a component in a soil treatment in accordance with principles of inventive concepts. Introducing an organic matter component treatment may increase microbial populations in soils, such as sandy soils, that lack organic matter, for example. Humus, which is widely available and may be derived from leonardite ore or other sources, may also provide physical restriction relief by opening pore spaces in the soil, thereby allowing more room for oxygen and water within the soil profile.

In example embodiments, vermicompost may be employed as a biological restriction relieving agent. Vermicompost, contains a plurality of beneficial bacteria and other microbes that are directly responsible for cycling nutrients in the soil and ecosystem. This direct infusion of biological activity into a plant/soil system increases nutrient availability, as well as the carbon dioxide/oxygen exchange that is at the heart of photosynthetic activity. In example embodiments different worm species and different worm food sources may be employed to generate different compositions of vermicompost, each of which may be particularly suitable for different soil types. In example embodiments composting earthworms, such as Eudrilus Eugniae, may be supported in sandless topsoil and “fed” organic matter such as ground grains, alfalfa, wheat germ, yeast, or human food waste, for example.

In an example embodiment a supplement may include a mix of 10% humus, 20% vermicompost and 70% calcium-contributing components, by weight. Other combinations are contemplated within the scope of inventive concepts, with vermicompost contributions of at least 5% by weight and humus contribution ranging from 0%-95%, and calcium-contributing ranging from 0%-95%.

In example embodiments a soil treatment in accordance with principles of inventive concepts provides a direct infusion of microbial populations through the addition of vermicompost.

In example embodiments in accordance with principles of inventive concepts a soil treatment may provide a direct infusion of microbial populations into a soil through its inclusion of vermicompost. This biological component, along with other biological components already present in the soil, may be enhanced by the addition of a component, such as an organic matter component, that provides a chemical (e.g., carbon) addition to the soil, which may act as a food source for the biological component provided by, for example, the vermicompost. In example embodiments, the inclusion of an organic matter component and vermicompost components provides, among other benefits, a synergy between a food source (an organic matter component) and microorganisms within the biological component (vermicompost) which may flourish on the food source.

In example embodiments in accordance with principles of inventive concepts a soil treatment may provide synergies in the physical realm, in that organic matter components provide physical soil-enhancing for all types of soils. For example, the negative polarity of organic matter components opens pore space in compacted soil, allowing more room for oxygen in the soil profile that, in turn, provides for beneficial microorganism proliferation. At the same time, in a completely different type of soil, non-compacted or sandy soil, the negative polarity and high carbon content of organic matter components provide physical benefits by enhancing the soils' ability to hold nutrients and water. Sandy, non-compacted, soils have very few exchange sites (naturally occurring negative charges on the soil colloid) to hold onto nutrients and water. Critical plant nutrients are primarily cations (with the exception of phosphates and nitrates); adding more negative charges/exchange sites to sandy soils, through the addition of an organic matter components, provide multiple physical benefits to soils. And, again, a combination of an organic matter components and vermicompost in accordance with principles of inventive concepts provides a synergistic benefit beyond what one would expect from the addition of either component to the soil.

In example embodiments a calcium-contributing component may improve nutrition availability in soils, primarily through a chemical mechanism: by adjusting the pH of the soil. But, additionally, a calcium-contributing component may ancillarily improve physical and biological characteristics of the soil. A combination of vermicompost with calcium-contributing and/or with an organic matter component-contributing components in accordance with principles of inventive concepts provides the benefits, not just of each individual component, but, through interactions among the components, enhances plan nutrition, vigor and growth in treated soils.

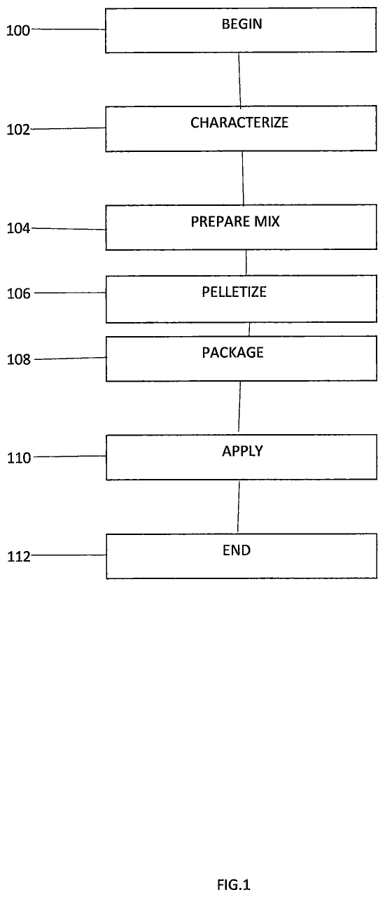

Turning now to the flowchart of FIG. 1, in example embodiments a process in accordance with principles of inventive concepts may begin in step 100 and proceed from there to step 102. Step 102 is an optional step, in which characteristics of a soil to be treated may be determined. Physical, chemical, and biological characteristics may be known, from prior testing on the soil or by assuming that the soil characteristics are similar to other local soils the characteristics of which are known, or such characteristics may be determined by testing conducted specifically for the purpose of a soil treatment in accordance with principles of inventive concepts.

From step 104, the process proceeds to step 106, where a treatment composition is formulated. As previously indicated, the treatment may be mix of vermicompost and either an organic matter component- or calcium-contributing components or a mix of all three, for example. The relative contributions of each component may vary, as previously indicated, and may be formulated for particular soil requirements (for example, more or less calcium depending upon the soil's pH level, more or less physical-restriction relief depending upon whether the soil is compacted or sandy, etc.). In example embodiments pre-set mixes may be prepared that address common soil compositions. For example, a mix may be directed at treatment of acidic soils, or of sandy soils, or a combination of physical, chemical, or biological characteristics. Such mixes may be manufactured on a relatively large scale and may be provided, prepackaged, to retail outlets, such as gardening stores, home stores, big-box stores, hardware stores or online, for example.

In step 106 a treatment mix in accordance with principles of inventive concepts may be formed for application. A mix may be formed into pellets (or prills, or granules, or beads), for example, which may be conveniently broadcast upon or mixed into soil for treatment. In some example embodiments, each component (e.g., gypsum, an organic matter component, and vermicompost) may be pelletized separately, then combined in a targeted proportion. In some example embodiments all components may be mixed in a targeted proportion, then pelletized, for example. In example embodiments one or more of the components may be reduced to a powder before pelletizing. That is, rather than screening components in their “natural” mineral state to select a particular size pellet one or more of the components may be crushed or otherwise reduced to a powder before being formed into a pellet. Not wishing to be bound by theory, but Applicant believes that substances of interest (chemical, biological, or physical) may be more readily available for plant nutrition if first reduced to a powder form before pelletizing. Additionally, pre-forming the one or more components into powder form may permit more thorough mixing for a more even, more homogeneous, distribution of components when applied to the soil. Generally, the smaller the pellet, the greater the efficiency and effectiveness of a treatment in accordance with principles of inventive concepts. Referring to the size guide number (SGN) terminology typically used in describing fertilizer, in turfgrass pellets, or prills, typically range from 80 to 300, with 80 being the smallest and, in example pellet embodiments any prill size may be employed, but a prill size of from 80 to 200 may be preferred and a prill size of 80 to 100 may be more preferred, and, in example embodiments a powdered form of treatment may be even more preferred. In example embodiments, all components of a treatment in accordance with principles of inventive concepts may be reduced to powder form, thoroughly mixed to produce a homogeneous mix and then used in powder form or compressed or otherwise pelletized to form homogeneous pellets for application to a soil.

In example embodiments a treatment in accordance with principles of inventive concepts may be packaged for use in, for example, a 60 lb. bag for use on 5,000 square feet of soil. In such an embodiment, the vermicompost component may range from 5% to 95% by weight (2.5 to 47.5 lbs.), or in a more preferrable embodiment, may range from 10% to 50% by weight (5 to 25 lbs.), or, in a still more preferrable embodiment, from 15% to 25% by weight (7.5 to 12.5 lbs.). In such an embodiment, a gypsum component may range from 5% to 95% by weight (2.5 to 47.5 lbs.), or in a more preferrable embodiment, may range from 30% to 90% by weight (15 to 45 lbs.), or, in a still more preferrable embodiment, from 60% to 80% by weight (30 to 40 lbs.). In such an embodiment, a humus component may range from 5% to 95% by weight (2.5 to 47.5 lbs.), or in a more preferrable embodiment, may range from 5% to 50% by weight (2.5 to 25 lbs.), or, in a still more preferrable embodiment, from 5% to 15% by weight (2.5 to 7.5 lbs.).

In golf course applications a treatment in accordance with principles of inventive concepts may be employed primarily for fairways and roughs, with more limited application for topdressing. Because topdressing is a process primarily employed to emphasize desirable physical characteristics of a putting green, by improving the greens' smoothness, increasing firmness and diluting thatch, a treatment in accordance with principles of inventive concepts may be employed intermittently in topdressing, rather than being employed every time a green is topdressed.

In step 108 a formulated mixture (whether in pellet, powder, or other form) may be packaged for end use. For retail applications the packaging may be in 6, 10, 14, 50 lb. or other standard bag sizes, for example. In example embodiments the mixture may be a dry (that is, not liquid) mixture, which may be more convenient for transportation, storage, and application, particularly when intended for use by homeowners on their lawns, but also for turf applications in golf, soccer, or other sports field applications.

In step 110 a treatment, whether bagged or not, in powder, pellet or other form, may be applied to the soil, by broadcasting the treatment on the soil, incorporating it into the soil (by tilling, for example) or other means. From step 110 the process proceeds to end in step 112. In example embodiments a treatment in accordance with principles of inventive concepts may be used on its own or may be combined with chemical fertilizers.

While the present inventive concepts have been particularly shown and described above with reference to example embodiments thereof, it will be understood by those of ordinary skill in the art, that various changes in form and detail can be made without departing from the spirit and scope of inventive concepts as defined by the following claims.

What is claimed is:

1. A soil treatment, comprising:
vermicompost; and
at least one chosen from the group of: a calcium source component, an organic component.

2. The soil treatment of claim 1, wherein the calcium source component is gypsum.

3. The soil treatment of claim 1, wherein the organic source component is humus.

4. The soil treatment of claim 1 wherein the vermicompost component is at least 5% by weight.

5. The soil treatment of claim 1 wherein the calcium treatment component is at least 5% by weight.

6. The soil treatment of claim 1, wherein the organic component is at least 5% by weight.

7. The soil treatment of claim 1, wherein the treatment is in powder form.

8. The soil treatment of claim 1, wherein the treatment is in pellet form.

9. A soil treatment, comprising:
a biological-restriction relieving component; and
at least one chosen from the group of: a chemical restriction relieving component, a physical restriction relieving component.

10. The soil treatment of claim 9, wherein the biological restriction relieving component includes vermicompost.

11. The soil treatment of claim 9, wherein the physical restriction relieving component includes gypsum.

12. The soil treatment of claim 9, wherein the chemical restriction relieving agent includes an organic material.

13. The soil treatment of claim 12, wherein the organic material is humus.

14. The soil treatment of claim 12, wherein the organic material includes fulvic acid.

15. The soil treatment of claim 12, wherein the organic material includes humic acid.

16. A method of treating soil, comprising:
preparing a mix of vermicompost and at least one from the group of: gypsum and humus; and
applying the mix to the soil.

17. The method of treating soil of claim 16, further comprising:
forming the mix into pellets before application to the soil.

18. The method of treating soil of claim 16, further comprising:
preparing the proportion of mix components according to physical, biological, or chemical characteristics of the soil to be treated.

19. The method of claim 18 wherein preparing the proportion of mix components includes the step of adjusting the level of a calcium-contributing component according to the acidity of the soil.

20. The method of claim 16, further comprising:
testing the soil to be treated for chemical, physical, or biological characteristics.
